(19) United States
(12) Patent Application Publication
(10) Pub. No.: US 2014/0078554 A1
(43) Pub. Date: Mar. 20, 2014

(54) IMAGE ARRANGEMENT DETERMINATION METHOD, NON-TRANSITORY COMPUTER-READABLE STORAGE MEDIUM HAVING PROGRAM STORED THEREON, IMAGE ARRANGEMENT DETERMINATION DEVICE, PRINTING DEVICE, AND DISPLAY DEVICE

(71) Applicant: CASIO COMPUTER CO., LTD., Tokyo (JP)

(72) Inventor: Katsuyoshi SUZUKI, Akiruno-shi (JP)

(73) Assignee: CASIO COMPUTER CO., LTD., Tokyo (JP)

(21) Appl. No.: 14/029,690

(22) Filed: Sep. 17, 2013

(30) Foreign Application Priority Data
Sep. 18, 2012 (JP) 2012-203871

(51) Int. Cl. G06K 15/02; B41J 29/38

(52) U.S. Cl. CPC G06K 15/1848; B41J 29/38
USPC 358/1.18; 347/5

(57) ABSTRACT

An image arrangement determination method includes distinguishing a series of a plurality of continuous shot data items created by continuous shooting from a plurality of image data items, detecting a movement direction of an object expressed by object data recorded in the distinguished series of the plurality of continuous shot data items from the series of the plurality of continuous shot data items, and determining a direction in which the plurality of continuous shot data items are to be arranged, based on the detected movement direction, and determining the arrangement of the series of the plurality of continuous shot data items such that the plurality of continuous shot data items are arranged in chronological order in the arrangement direction.

### CROSS-REFERENCE TO RELATED APPLICATIONS

This application is based upon and claims the benefit of priority from prior Japanese Patent Application No. 2012-203871, filed Sep. 18, 2012, the entire contents of which are incorporated herein by reference.

### BACKGROUND OF THE INVENTION

1. Field of the Invention

The present invention relates to an image arrangement determination method, computer-readable storage medium having a program stored thereon, image arrangement determination device, printing device, and display device.

2. Description of the Related Art

In recent years, household printing devices capable of printing an address, image, sentence, and the like on a postcard are widespread. It has become possible, by using these devices, to print addresses and sentences of New Year's cards, summer greeting cards or the like on a massive scale.

Further, some of the printing devices are equipped with a memory card in which images taken by a camera are stored, whereby they are provided with a function of printing images by selection or a function of printing an index print constituted of a plurality of images.

Further, in Jpn. Pat. Appln. KOKAI Publication No. 10-51716, a printer which makes it possible to enhance the expressive power by acquiring an effective arrangement corresponding to the contents of an image with respect to the capturing order of a plurality of continuous shot data items is disclosed. This printer is configured to cause the user to select one of a lateral arrangement state, longitudinal arrangement state, right-handed arrangement state, and left-handed arrangement state with respect to a layout to be employed when a plurality of images are arranged in a plurality of rows and in a plurality of columns.

However, the device of above-mentioned Jpn. Pat. Appln. KOKAI Publication No. 10-51716 is configured to enable layout change by selection from a plurality of arrangements, and is not configured to automatically determine a legible arrangement corresponding to a change of the image.

### BRIEF SUMMARY OF THE INVENTION

According to one aspect of the present invention, there is provided an image arrangement determination method comprising: distinguishing a series of a plurality of continuous shot data items created by continuous shooting from a plurality of image data items; detecting a movement direction of an object expressed by object data recorded in the distinguished series of the plurality of continuous shot data items from the series of the plurality of continuous shot data items; and determining a direction in which the plurality of continuous shot data items are to be arranged, based on the detected movement direction, and determining the arrangement of the series of the plurality of continuous shot data items such that the plurality of continuous shot data items are arranged in chronological order in the arrangement direction.

According to another aspect of the present invention, there is provided a non-transitory computer-readable storage medium having a program stored thereon which controls a computer to perform functions comprising: distinguishing a series of a plurality of continuous shot data items created by continuous shooting from a plurality of image data items stored in a storage unit, detecting a movement direction of an object expressed by object data recorded in the distinguished series of the plurality of continuous shot data items from the series of the plurality of continuous shot data items, and determining a direction in which the series of the plurality of continuous shot data items are to be arranged, based on the detected movement direction, and determining the arrangement of the series of the plurality of continuous shot data items such that the plurality of continuous shot data items are arranged in chronological order in the arrangement direction.

According to still another aspect of the present invention, there is provided an image arrangement determination device comprising: a control unit configured to read a plurality of image data items stored in a storage unit, wherein the control unit is configured to: distinguish a series of a plurality of continuous shot data items created by continuous shooting from the plurality of image data items, detect a movement direction of an object expressed by object data recorded in the distinguished series of the plurality of continuous shot data items from the series of the plurality of continuous shot data items, and determine a direction in which the plurality of continuous shot data items are to be arranged, based on the detected movement direction, and determine the arrangement of the series of the plurality of continuous shot data items such that the plurality of continuous shot data items are arranged in chronological order in the arrangement direction.

According to further aspect of the present invention, there is provided a printing device comprising: a control unit configured to read a plurality of image data items stored in a storage unit; and a printing unit configured to print the image data items read by the control unit on a medium, wherein the control unit is configured to: distinguish a series of a plurality of continuous shot data items created by continuous shooting from the plurality of image data items, detect a movement direction of an object expressed by object data recorded in the distinguished series of the plurality of continuous shot data items from the series of the plurality of continuous shot data items, determine a direction in which the plurality of continuous shot data items are to be arranged, based on the detected movement direction, and determine the arrangement of the series of the plurality of continuous shot data items such that the plurality of continuous shot data items are arranged in chronological order in the arrangement direction, and cause the printing unit to print the series of the plurality of continuous shot data items on the medium in accordance with the determined arrangement.

According to still further aspect of the present invention, there is provided a display device comprising: a control unit configured to read an image data item from a storage unit in which a plurality of image data items are stored; and a display unit configured to display the image data item read by the control unit, wherein the control unit is configured to: distinguish a series of a plurality of continuous shot data items created by continuous shooting from the plurality of image data items stored in the storage unit, detect a movement direction of an object expressed by object data recorded in the distinguished series of the plurality of continuous shot data items from the series of the plurality of continuous shot data items, determine a direction in which the plurality of continuous shot data items are to be arranged, based on the detected movement direction, and determine the arrangement of the series of the plurality of continuous shot data items such that the plurality of continuous shot data items are arranged in chronological order in the arrangement direction, and cause the display unit to display the series of the plurality of continuous shot data items in accordance with the determined arrangement.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a printing device according to an embodiment of the present invention.

FIG. 2 is an explanatory view showing a keyboard of the printing device according to the embodiment of the present invention.

FIG. 3 is a schematic cross-sectional view of the printing device according to the embodiment of the present invention.

FIG. 4 is a functional block diagram of the printing device according to the embodiment of the present invention.

FIG. 5 is a view of an example of continuous shots read by the printing device according to the embodiment of the present invention.

FIG. 6 is a view obtained by arranging the continuous shots read by the printing device according to the embodiment of the present invention in a predetermined order.

FIG. 7 is a view of an example of another series of continuous shots read by the printing device according to the embodiment of the present invention.

FIG. 8 is a view obtained by arranging another series of continuous shots read by the printing device according to the embodiment of the present invention in a predetermined order.

FIG. 9 is a flowchart showing a flow of arrangement processing of index print to be carried out by the printing device according to the embodiment of the present invention.

### DETAILED DESCRIPTION OF THE INVENTION

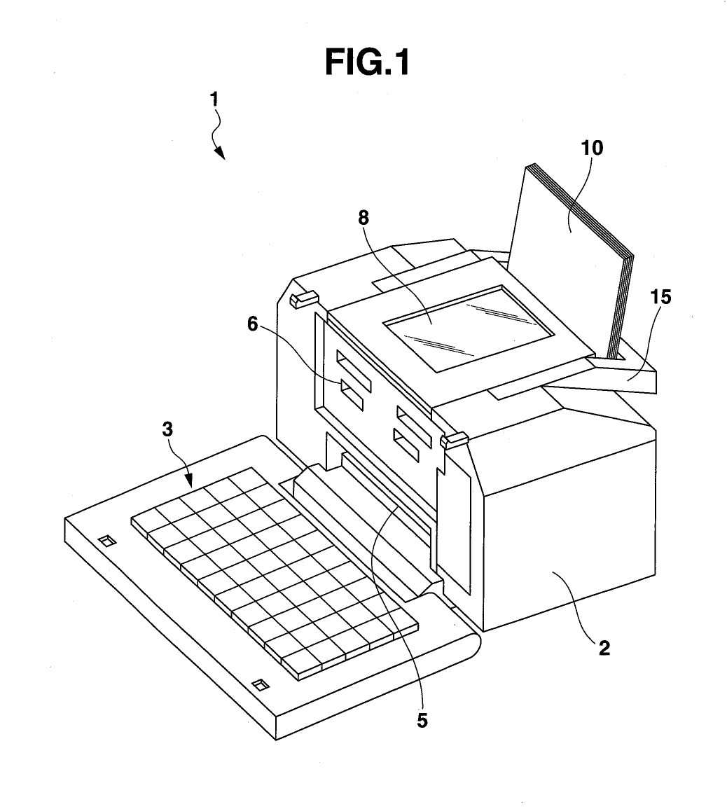

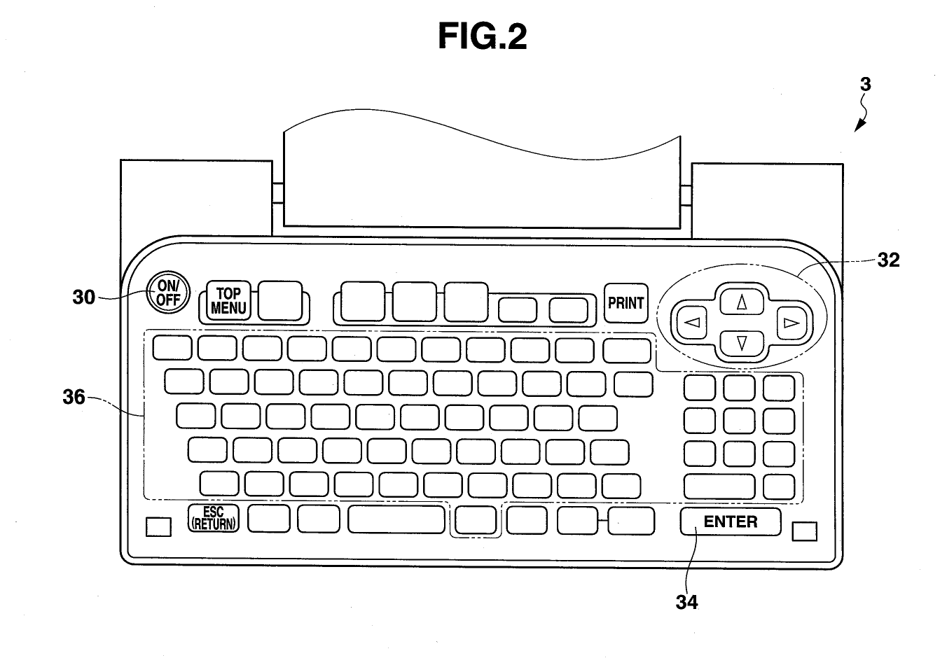

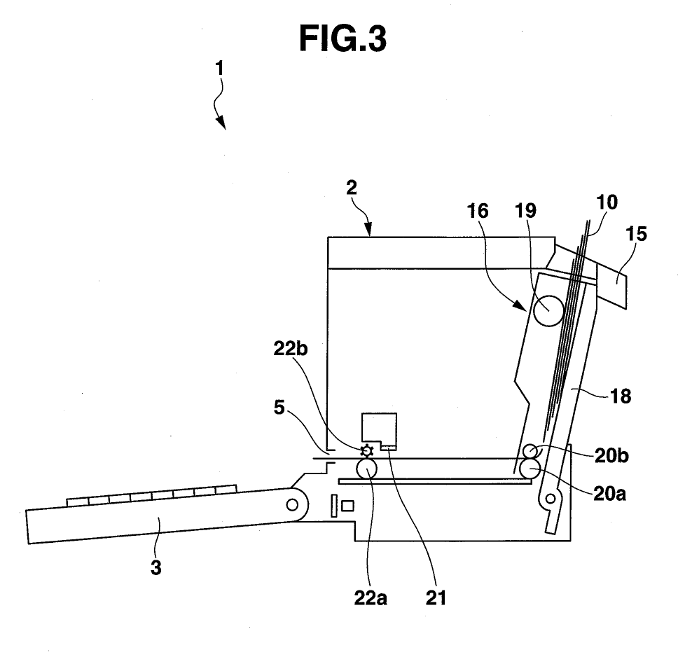

Hereinafter, an embodiment of the present invention will be described in detail with reference to the drawings. FIG. 1 is an external perspective view of a printing device 1 according to the embodiment of the present invention, FIG. 2 is an explanatory view showing a keyboard of the printing device according to the embodiment of the present invention, and FIG. 3 is a schematic side cross-sectional view of the printing device 1. The printing device 1 is a device configured to execute printing on a medium to be printed 10 serving as a recording medium such as a postcard (100×148 mm), photographic paper of the L size (89×127 mm), 2 L size (178×127 mm) or the like, and is provided with various functions such as a function of creating an address list, function of automatically addressing a postcard on the basis of an address list, function of reading a photographic image taken by a digital camera, and printing the image as a photograph, function of editing a sentence, function of combining a read image and a sentence with each other, and printing the combined data on a postcard, and the like. Further, the printing device 1 is configured to print a series of a plurality of continuous shot data items on a medium to be printed in accordance with an arrangement determined by the image arrangement method of the present invention. Furthermore, the printing device 1 is configured to display a series of a plurality of continuous shot data items on a display unit 8 in accordance with an arrangement determined by the image arrangement method of the present invention, whereby the device 1 functions also as a display device of the present invention.

As shown in FIG. 1, the printing device 1 is provided with a box-like housing 2 including a paper feed tray, and display unit 8 at an upper part thereof, and a keyboard 3 is arranged in front of the housing 2. The keyboard 3 is rotatably attached to a part near a front lower end of the housing 2. In the usage state, the keyboard 3 is forwardly lowered as shown in FIG. 1 and, when not in use, the keyboard 3 is held in a vertical state where it is opposed to the front face of the housing 2.

On the keyboard 3, as shown in FIG. 2, a power switch key 30 configured to turn on/off the power, cursor key 32 configured to select an item or to change the set contents of a selected item, enter key 34 configured to determine the selected object or the changed contents in order to advance the operation, top menu key configured to display a top menu screen on the display unit 8, print key used for instructions to execute printing, character/numeric keys 36 configured to enter characters or numerals, and the like are arranged, and a predetermined operation signal is transmitted to a control unit 41 to be described later on the basis of an input operation of the user.

In the front face of the housing 2, a paper ejection opening 5 from which a medium to be printed 10 such as a postcard, photograph or the like that has been already printed is ejected, and storage medium insertion openings 6 into which attachable/detachable portable storage media such as memory cards or the like can be inserted are formed. Attachable/detachable portable storage media such as memory cards or the like are inserted into the storage medium insertion openings 6, whereby it is made possible for edited data such as a sentence edited by a personal computer, and an address list file constituted of a plurality of address data items to be captured in the printing device 1, and it is made possible for data edited by the printing device 1 to be saved on a memory card or the like.

Further, on the top surface of the housing 2, the display unit 8 of a liquid crystal panel or the like is arranged, and the display unit 8 is made rotatable in the front direction on the upper part of the housing 2. On the display unit 8, input contents are displayed on the screen in accordance with an input signal from the keyboard 3, or a menu screen necessary for various setting operations is displayed, or a photographic image read from a digital camera is displayed, i.e., various data items necessary for the printing device 1 are displayed. It should be noted that the display unit 8 is also constituted as a touch panel in some cases. By constituting the display unit 8 as a touch panel, a simple input operation is enabled on the display unit 8 without using the keyboard 3.

Furthermore, to the upper part of the housing 2, a carrying handle 15 made rotatable between the rear side of the housing 2 and above the housing 2 is attached. The carrying handle 15 is roughly formed into a U-shape, and is gripped and used at the time of transportation or the like of the printing device 1.

Further, as shown in FIG. 3, the printing device 1 includes a cavity unit 16 opened on the backside of the housing 2, and a paper feed tray 18 is arranged to close the opening of the cavity unit 16. The paper feed tray 18 is rotatably attached to a part of the housing 2 in the rear thereof and, at a position near the lower part thereof, is made rotatable so that the upper end of the tray 18 can be moved in the front-back direction, and is configured to accommodate a plurality of thicknesses of media to be printed 10.

Further, at a position inside and above the paper feed tray 18, a pickup roller 19 configured to downwardly send the media to be printed 10 accommodated in the paper feed tray 18 one by one is arranged. Further, near the lower end of the paper feed tray 18, transfer rollers 20a and 20b configured to transfer the medium to be printed 10 downwardly sent by the pickup roller 19 in the direction of the paper ejection opening 5 of the housing 2 are arranged. Further, inside the housing 2, and in front of a print head 21, paper ejection rollers 22a and 22b configured to eject a medium to be printed 10 for which printing has been completed from the paper ejection opening 5 are arranged. The transfer roller 20a and paper ejection roller 22a are rotation-controlled by a stepping motor (not shown) to thereby transfer the medium to be printed 10 at a predetermined speed. It should be noted that the pickup roller 19, transfer rollers 20a and 20b, and paper ejection rollers 22a and 22b function as a transfer unit in the printing device 1.

The print head 21 as a print unit is arranged inside the device near the paper ejection opening 5. The print head 21 is a print head of an ink-jet system including nozzles each configured to eject ink of each of Y (yellow), M (magenta), and C (cyan), and directs a jet of ink of each color at the medium to be printed 10 from each nozzle to thereby execute printing. It should be noted that although the print head 21 of the ink-jet system has been described above, the present invention is not limited to the ink-jet system.

Further, the media to be printed 10 accommodated in the paper feed tray 18 are downwardly sent in sequence in the order from the medium to be printed 10 positioned on the front side by the pickup roller 19, are paid out toward a position below the print head 21 inside the device near the paper ejection opening 5 in a state where each of the media 10 is pinched between the transfer rollers 20a and 20b and, after the printing is completed, are ejected from the paper ejection opening 5 to the outside by being pinched between the paper ejection rollers 22a and 22b.

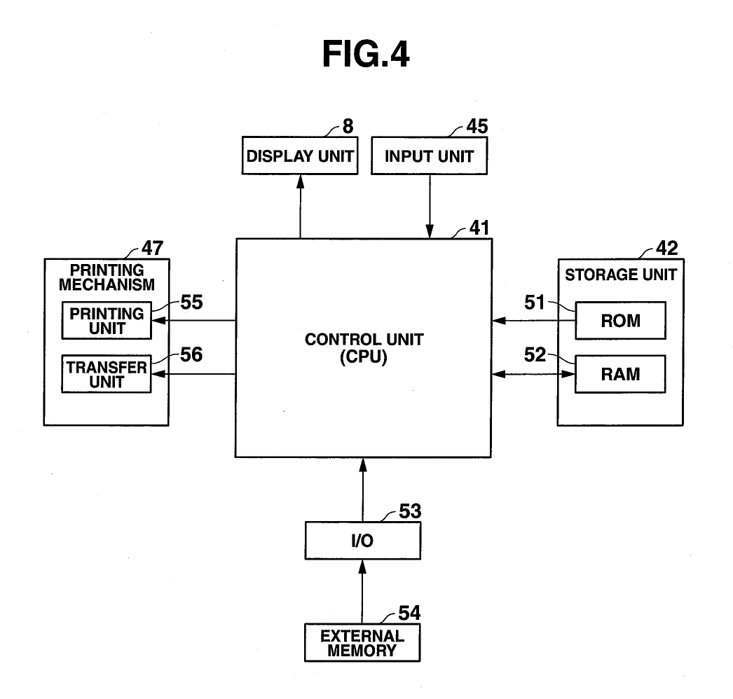

Next, a control circuit of the printing device 1 of this embodiment will be described below. FIG. 4 is a functional circuit block diagram of the printing device 1. As shown in FIG. 4, the printing device 1 is provided with a control unit 41 configured to manage the whole system, storage unit 42 constituted of a ROM 51 and RAM 52, the display unit 8, input unit 45, printing mechanism 47, and I/O 53.

In the ROM 51, a program, typographical fonts, and the like used to display or print set character string data or the like are stored, and the ROM 51 also functions as a storage medium in which a program that can be read by the control unit 41 is stored.

Further, the I/O 53 is configured to read data of an external memory 54 such as a memory card or the like to be inserted into the storage medium insertion opening 6, and transmit the read data to the control unit 41.

Further, the ROM 51 is configured to be rewritable by use of a flash memory, and also serves as an image data storage unit controlled by the control unit 41 and configured to read and store therein image data which is to be stored in the memory card or the like.

Further, in the RAM 52, a print data memory area storing therein print pattern data in which input printing information is spread, display data memory area storing therein pattern data to be displayed on the display unit, and like are secured, and a register configured to temporarily store therein data necessary for printing processing, image processing, and the like, and counter, and the like are also provided.

The input unit 45 is the above-mentioned keyboard 3 which is used by the user for input operations, and is a user interface for selection of various modes. The input unit 45 is provided with a power switch key 30, cursor key 32, enter key 34, print key, and the like. The display unit 8 is the above-mentioned liquid crystal panel or the like configured to display various operation screens and display image data, and is controlled by the control unit 41 which has received a predetermined operation signal to thereby display a predetermined operation screen of a plurality of operation screens. It should be noted that when a touch panel is provided on the surface of the display unit 8, the input unit 45 includes the touch panel.

The printing mechanism 47 is constituted of a printing unit 55, and transfer unit 56. The printing unit 55 corresponds to the above-mentioned print head 21, and carries out processing of executing printing on the medium to be printed 10. Further, the transfer unit 56 is constituted of the above-mentioned pickup roller 19, transfer rollers 20a and 20b, paper ejection rollers 22a and 22b, and stepping motor configured to rotate the rollers, and carries out processing of transferring the medium to be printed 10.

The control unit 41 is constituted of a CPU, starts a system program stored in advance in the ROM 51, control program stored in the memory card, and the like in accordance with a key operation signal from the input unit 45 or automatically, and controls operations of the circuit units by using the RAM 52 as a work memory.

Further, the control unit 41 of the present invention functions as a continuous shot data distinguishing unit configured to distinguish between a single-shot image and continuous shot image in the plurality of image data items stored in the image storage unit of the ROM 51. The continuous shot data distinguishing unit is configured to detect the number of image data items of the distinguished continuous shots. It should be noted that the continuous shot data distinguishing unit is configured to distinguish between the background and object with respect to a plurality of continuous shot data items by image recognition to thereby detect whether or not the image is one of continuous shots, and detect whether or not the image is one of continuous shots on the basis of object data which is adjunct data of the shot data, and the shooting date. Further, the continuous shot data distinguishing unit may be configured to read header information of the image and, when a continuous shot flag is set, determine that the image is one of continuous shots. In this case, it is sufficient if a digital camera is configured to set a continuous shot flag included in the header of the shot image when a continuous shooting mode is set at the time of shooting by using the digital camera.

Furthermore, the control unit 41 also functions as a movement direction detecting unit configured to detect a movement direction of the object or the whole image from the plurality of continuous shot data items detected by itself serving as the continuous shot data distinguishing unit. The movement direction detecting unit is configured to detect, on the basis of a plurality of image data items of the continuous shots, the movement direction of the object or the whole image, i.e., whether or not the movement feature point has moved in one of upward, downward, rightward, and leftward directions.

Further, the control unit 41 also functions as an image arranging unit configured to determine an arrangement direction on the index print which is a medium of a plurality of printed images formed by printing a plurality of continuous shot data items on a medium in accordance with the movement direction detected by itself serving as the movement direction detecting unit, and thereby determine the arrangement of the plurality of printed images such that the plurality of printed images are arranged in chronological order in the arrangement direction.

It should be noted that in the printing device 1 of the present invention, a print mode of the index print is made selectable in the input unit, and when the index print of image data items of continuous shots which have been stored in a memory card or the like and read into the image storage unit, is to be created in the print mode for the index print, the number of lines of the continuous shots is made settable in the input unit.

Further, in the input unit, the number of continuous shots in one line in the index print is made settable.

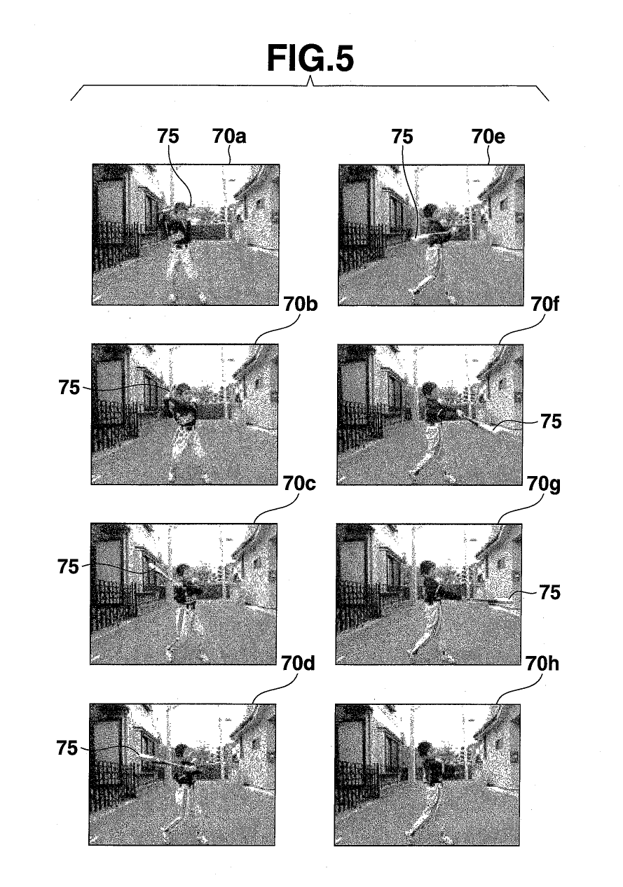

Next, an image arrangement determination method to be carried out by the image arrangement determination device applied to the printing device 1 of the present invention when the arrangement of the index print is to be changed to that of a predetermined direction will be described below by using the drawings. FIG. 5 is a view showing, as an example of continuous shots, eight image data items formed by shooting a series of operations of a boy swinging a baseball bat.

In the printing device 1, there are a case where a memory card in which a large number of image data items shot by a digital camera or the like are stored is attached to the device 1, and images are selected and printed, and a case where the index print is to be printed so that a large number of images can be glanced.

Further, continuously shot images of a sporting scene shot at several frames per second are included in the large number of image data items in some cases. When these continuous shots are printed frame by frame, the change in the scene is not easy to see. Conversely, when the continuous shots are printed as the index print in which the images are arranged on one sheet, the dynamic change can be perceived.

It is should be noted that, in the index print, when the arrangement is associated with the landscape orientation, basically, the first image is arranged at the upper left, subsequent images are arranged rightward in sequence and, when a predetermined number of images are arranged, the arrangement is shifted to the lower line. Further, the next image is arranged at the left end again, and the same arrangement is repeated.

In the continuous shots of a sporting scene or the like, there are various cases, depending on the shot composition, shooting conditions or the like. A case where movement is carried out from right to left, case where movement is carried out from left to right, case where movement is carried out from down to above, case where movement is carried out diagonally, and so on are possible.

That is, by making the movement direction of the continuous shots and arrangement direction of the images in the index print equal to each other, it is possible to obtain an index print that is easy to see.

In the case of the continuous shot data items formed by shooting a series of operations of a boy swinging the baseball bat as shown in FIG. 5 taken as an example of continuous shots, the swing of the bat that is the movement feature point 75 is gradually started from the first continuous shot data item 70a in which the bat is held over the boy's head, and the swing of the bat that is the movement feature point 75 is moved from left to right as indicated in the second continuous shot data item 70b, third continuous shot data item 70c, fourth continuous shot data item 70d, fifth continuous shot data item 70e, sixth continuous shot data item 70f, and seventh continuous shot data item 70g, and an image in which the bat is fully swung all the way through is shown in the eighth continuous shot data item 70h.

That is, in the continuous shots based on the bat swing shown in FIG. 5, there is no change in the background of the whole image in terms of the image data in each of the images, the movement feature point 75 based on the bat is extracted as a point of variation in each of the images, and is moved from left to right.

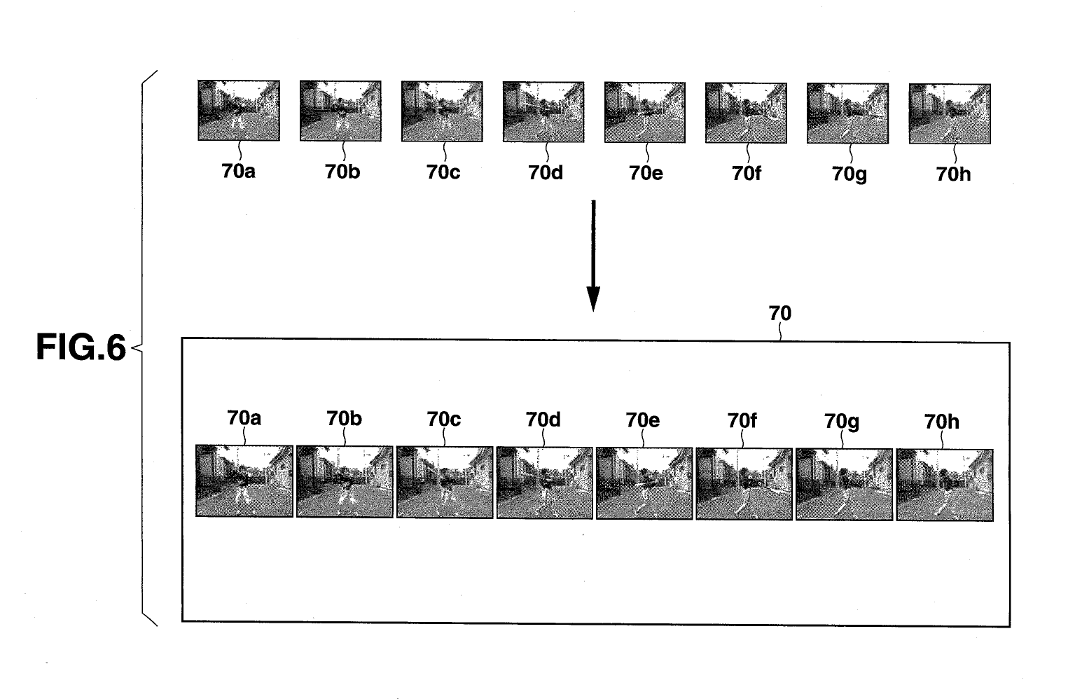

Accordingly, the printing device 1 arranges the continuous shots which move from left to right as the rightward movement index print 70 shown in FIG. 6 in accordance with the shooting order such that the first continuous shot data item 70a is arranged at the left end, subsequently the second continuous shot data item 70b, third continuous shot data item 70c, fourth continuous shot data item 70d, fifth continuous shot data item 70e, sixth continuous shot data item 70f, and seventh continuous shot data item 70g are arranged in sequence on the right side of the first continuous shot data item 70a, and the eighth continuous shot data item 70h is arranged at the rightmost end.

Thereby, in the rightward movement index print 70 shown in FIG. 6, the same arrangement configuration as the movement of the continuous shots has been established, the continuous shots are made easy to see naturally, and the movement of the bat swing is dynamically depicted. It should be noted that the printing device 1 may be configured to display contents equal to the output contents of the index print 70 which are intended to be printed from now in the same arrangement order as the index print on the display unit 8 prior to printing of the index print 70. Thereby, it is possible for the user to previously confirm the output contents of the index print 70 which the user intends to print from now, and prevent unintended printing from being executed.

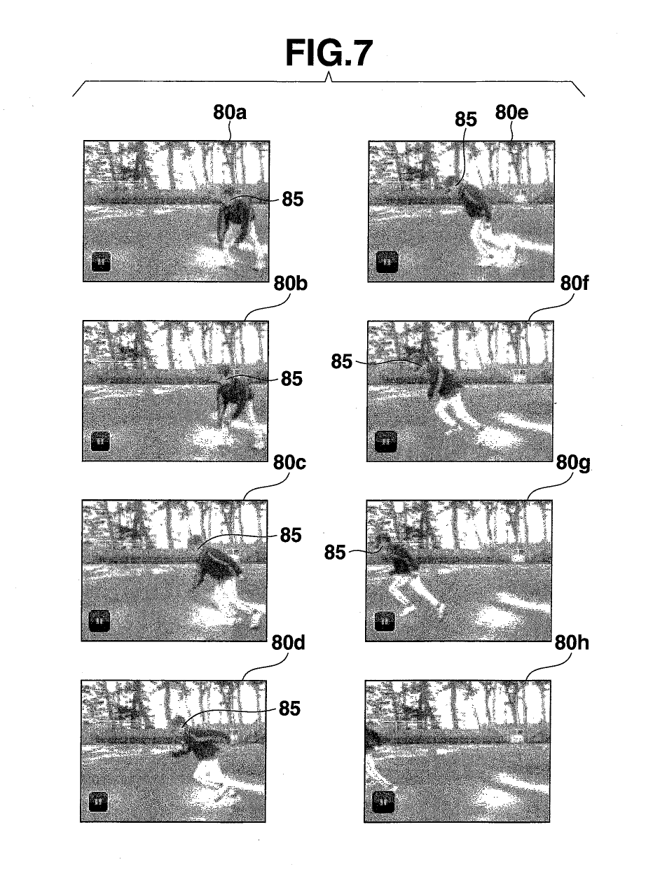

Further, in the case of the continuous shot data items formed by shooting a series of movements of a person running as shown in FIG. 7 as an example of continuous shots, at first, beginning with the first continuous shot data item 80a showing the state where the person depicted on the right side is just about to start running, then the head part of the person to be regarded as the movement feature point 85 moves from right to left in proportion to the progress of the second continuous shot data item 80b, third continuous shot data item 80c, fourth continuous shot data item 80d, fifth continuous shot data item 80e, sixth continuous shot data item 80f, seventh continuous shot data item 80g and, in the eighth continuous shot data item 80h, an image showing the state where the person is almost out of the left end is depicted.

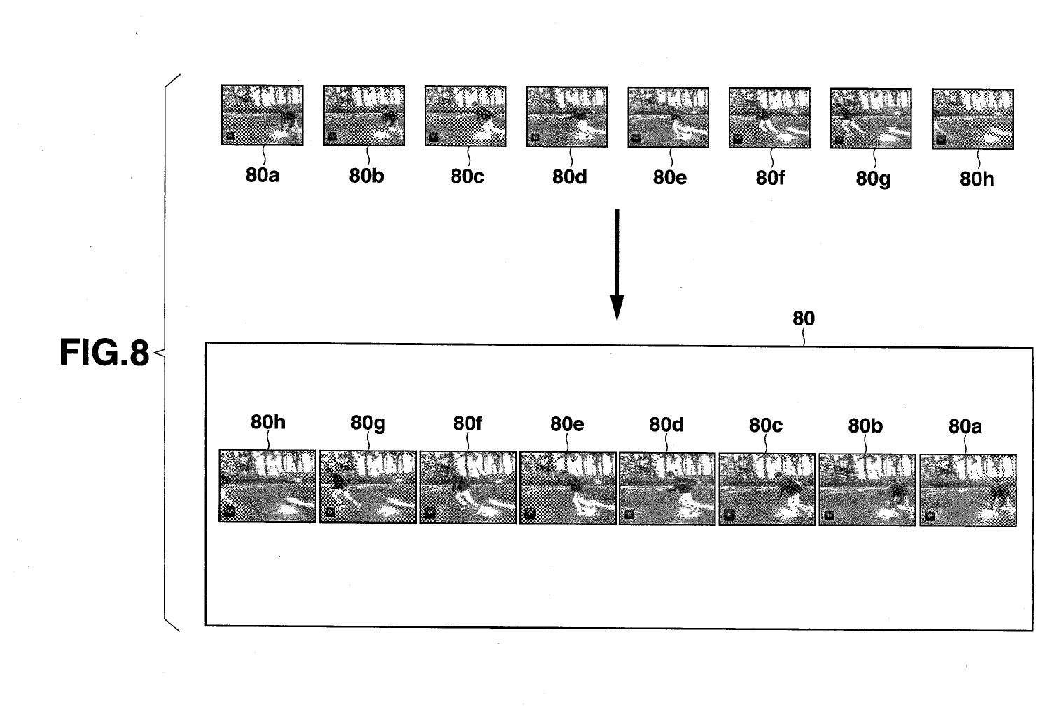

That is, the continuous movement of the running motion of the person shown in FIG. 7 is the movement of the person from right to left. Accordingly, in the printing device 1, the continuous shots moving from right to left are arranged as the leftward movement index print 80 as shown in FIG. 8 in the order reverse to the shooting order such that the eighth continuous shot data item 80h is arranged at the left end; subsequently, the seventh continuous shot data item 80g, sixth continuous shot data item 80f, fifth continuous shot data item 80e, fourth continuous shot data item 80d, third continuous shot data item 80c, and second continuous shot data item 80b are arranged in sequence on the right side of the eighth continuous shot data item 80h, and the first continuous shot data item 80a which is the first frame of the continuous shots is arranged at the rightmost end.

Thereby, in the leftward movement index print 80 shown in FIG. 8, the arrangement order is made different from the shooting order, and the arrangement configuration similar to the movement of the continuous shots is established. Further, the continuous shots are made easy to see naturally, and the movement of the running person is dynamically depicted. In this case too, the printing device 1 may be configured to display contents equal to the output contents of the index print 80 which are intended to be printed from now in the same arrangement order as the index print 80 on the display unit 8 prior to printing of the index print 80.

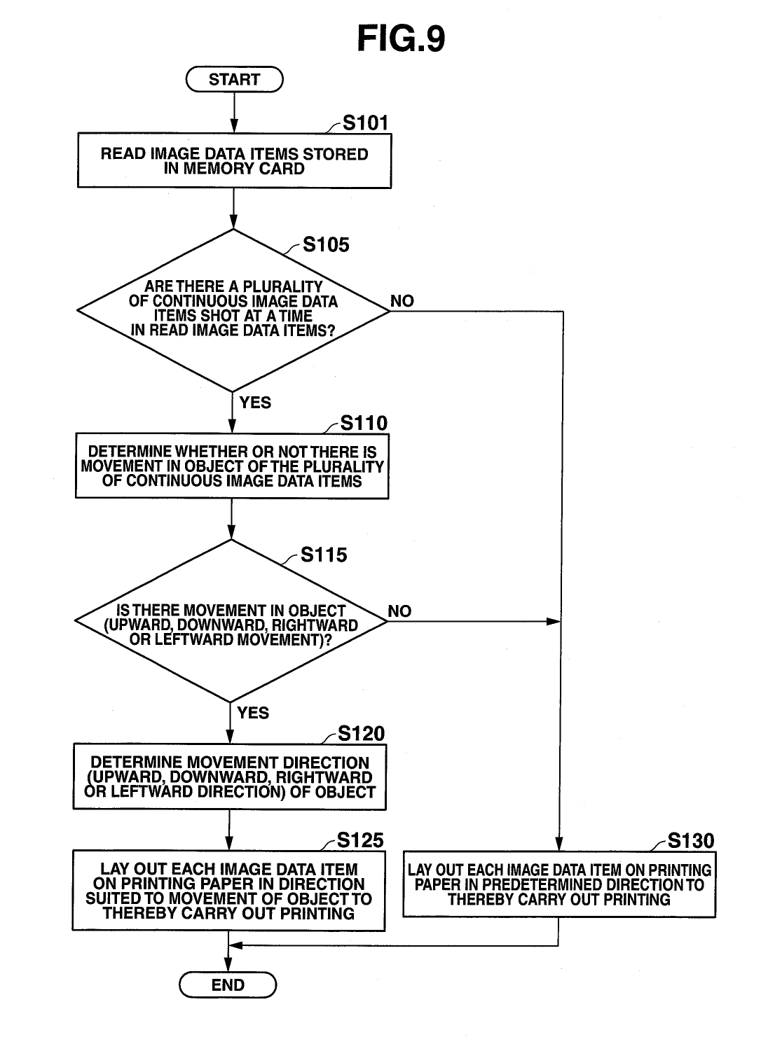

Next, a flow of the process up to printing of the index print 70 or 80 of the printing device 1 of the present invention will be described below by using a flowchart. FIG. 9 is a flowchart showing a flow of arrangement processing of the index print 70 or 80 to be carried out by the printing device 1 according to the embodiment of the present invention.

When the input unit is operated by the user, and a print mode of index print is input, the control unit 41 executes processing (step S101) of reading all the image data items stored in a memory card or the like into the image storage unit of the ROM 51.

Next, the control unit 41 spreads, as the continuous shot data distinguishing unit, all the image data items stored in the ROM 51 in a work area of the RAM 52, distinguishes between a single-shot image and continuous shot image on the basis of determination acquired by image processing or data of the shooting date/time, and carries out determination about presence/absence of continuous shots (step S105). Further, the continuous shot data distinguishing unit also detects the number of image data items of the continuous shots, and the number is used to determine the number of data items in one lateral line of the continuous shots of the index print.

In the determination (step S105) of presence/absence of continuous shots, when all the read image data items are single-shot data items, the flow is advanced to step S130, and all the read image data items are laid out in a direction (for example, arrangement is started from the upper left end, and the subsequent image data items are arranged in sequence on the right) conforming to the normal arrangement rule of the medium to be printed to thereby print the index print and terminate the processing.

In the determination (step S105) about presence/absence of continuous shots, when continuous shots are included in the read image data items, the flow is advanced to step S110, and the control unit 41 carries out, as the continuous shot data distinguishing unit, image processing (step S110) based on the comparative recognition of the background images of the continuous shot group and object images in order to detect whether or not there is any movement in the object or the whole image from the plurality of detected continuous shots.

Next, the control unit 41 determines (step S115) whether or not there is any movement in the object or the whole image on the basis of the image processing (step S110) carried out by the continuous shot data distinguishing unit.

Further, in the movement determination (step S115), when it is determined that there is no movement in the read continuous shots, and all the images are still images, the flow is advanced to step S130, and index print of the images conforming to the aforementioned image arrangement rule is printed, thereby terminating the processing.

Further, in the movement determination (step S115), when it is determined that there is movement in the read continuous shots, the control unit 41 functioning as the movement direction detecting unit detects the moving direction of the whole visual field such as the background image or the like or a change in only part of the images on the basis of a plurality of image data items of the continuous shots, and analyzes the movement direction of the object or the whole image on the basis of the aforementioned movement feature point to thereby detect whether or not the object or the whole image has moved in one of upward, downward, rightward, and leftward directions (step S120).

The control unit 41 functioning as the image arranging unit determines the arrangement of the image data items of the index print in accordance with the previously detected direction (upward, downward, rightward or leftward direction) of the movement, and controls the printing unit or the like to thereby carry out printing (step S125) of the index print and terminate the processing.

It should be noted that in the printing device 1 of the present invention, the print mode of the index print is made selectable in the input unit and, in the input unit, when index print of image data items of continuous shots which have been stored in a memory card or the like and read into the image storage unit, is to be created in the print mode of the index print, the number of lines of continuous shots of the continuous shot index print is made settable. For example, when a condition of “eight image data items per line” is set, an index print in which eight image data items are arranged in a line is created as shown in FIG. 6 or FIG. 8.

Further, the number of image data items in one line is not limited to eight. It is possible to reduce the number of image data items in one line to, for example, four to thereby print each image data item in a larger size, make the number of image data items in one line equal to the number of continuous shots, and employ a plurality of lines to thereby arrange a large number of image data items.

It should be noted that the image arranging unit of the present invention is configured to determine the arrangement of image data items of the index print in accordance with the direction of the movement, and control the printing unit or the like to thereby carry out printing of the index print. Further, the image arranging unit is configured to, even when a still image, microtremor image or the like is included in the continuous shots in the movement direction detecting unit, arrange the images in the aforementioned direction, and carry out printing of the images if more than half the number of movement feature points of the whole continuous shots have moved in the same direction.

Further, the image arranging unit of the present invention is configured to determine an arrangement of image data items of the index print in accordance with the direction of the movement, control the printing unit or the like, and carry out printing of the index print. When the moving direction of the continuous shots is, for example, one of diagonal directions or upward/downward directions in the movement direction detecting unit, it is sufficient if the images are arranged in accordance with the moving direction, and are printed as the index print.

It should be noted that although an example in which the printing device 1 is employed with respect to the image arrangement determination device of the present invention has been described above, the explanation is not limited to this and, the present invention is applicable to all types of devices configured to rearrange images and rearrange continuous shots in a direction in which the images are easy to see.

As described above, according to this embodiment, it is possible to provide an image arrangement determination method which makes the movement of the object natural, and makes a change in the movement easy-to-see by automatically detecting the movement of the object in the continuous shots based on a series of continuous movements, and laying out the images in the optimum direction, non-transitory computer-readable storage medium having a program stored thereon, image arrangement determination device, printing device, and display device.

Furthermore, according to this embodiment, it is possible to quickly determine the number of image data items of the index print to be arranged laterally or vertically by detecting the number of image data items of the distinguished continuous shots.

Further, according to this embodiment, an arrangement conforming to the movement is enabled by detecting the movement direction of the object.

Further, according to this embodiment, it is possible to print an index print of a plurality of lines by setting the number of lines of continuous shots in the index print if the continuous shots are constituted of a large number of images.

Furthermore, according to this embodiment, it is possible to print an index print in which the number of image data items of the continuous shots, and size of the image are taken into consideration by setting the number of image data items in one line of the continuous shots in the index print.

Furthermore, it is also possible to apply the processing in the embodiment of the present invention to various types of devices in a state where the processing is written to a storage medium such as a magnetic disk, optical disk, semiconductor memory or the like as a printing control program which can be realized by a computer or to various types of devices by transmitting the program to the devices by means of a communication medium. By storing each of the processing items described in this embodiment in a desired storage medium as described above, and causing another computer or the like to execute the control program, it is possible to obtain the same function and advantage as in the case where the device of this embodiment is used. It should be noted that the computer is not limited to the computer incorporated in the device described in this embodiment, and the above-mentioned computer implies all types of computers each of which is provided with an arithmetic device such as a CPU or the like capable of reading the printing control program stored in a storage medium, and configured to carry out control operations in accordance with the read control program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image arrangement determination method comprising:
distinguishing a series of a plurality of continuous shot data items created by continuous shooting from a plurality of image data items;
detecting a movement direction of an object expressed by object data recorded in the distinguished series of the plurality of continuous shot data items from the series of the plurality of continuous shot data items; and
determining a direction in which the plurality of continuous shot data items are to be arranged, based on the detected movement direction, and determining the arrangement of the series of the plurality of continuous shot data items such that the plurality of continuous shot data items are arranged in chronological order in the arrangement direction.

2. The image arrangement determination method according to claim 1, wherein when the series of the plurality of continuous shot data items are to be distinguished, the number of the distinguished series of the plurality of continuous shot data items is detected.

3. The image arrangement determination method according to claim 1, wherein when the movement direction is to be detected, it is detected which one of upward, downward, rightward, and leftward directions is the movement direction of the object, based on the object data recorded in the series of the plurality of continuous shot data items.

4. The image arrangement determination method according to claim 1, wherein the arrangement of the series of the plurality of continuous shot data items is determined such that the plurality of continuous shot data items are arranged in lines of a predetermined number greater than or equal to one.

5. The image arrangement determination method according to claim 4, wherein the arrangement of the series of the plurality of continuous shot data items is determined such that images of a predetermined number are arranged in each of the lines of the number greater than or equal to one.

6. The image arrangement determination method according to claim 1, wherein the detected movement direction is a direction from right to left.

7. A non-transitory computer-readable storage medium having a program stored thereon which controls a computer to perform functions comprising:
distinguishing a series of a plurality of continuous shot data items created by continuous shooting from a plurality of image data items stored in a storage unit,
detecting a movement direction of an object expressed by object data recorded in the distinguished series of the plurality of continuous shot data items from the series of the plurality of continuous shot data items, and
determining a direction in which the series of the plurality of continuous shot data items are to be arranged, based on the detected movement direction, and determining the arrangement of the series of the plurality of continuous shot data items such that the plurality of continuous shot data items are arranged in chronological order in the arrangement direction.

8. The non-transitory computer-readable storage medium according to claim 7, wherein the program controls the computer to detect the number of the distinguished plurality of continuous shot data items when the program controls the computer to distinguish the continuous shot data items.

9. The non-transitory computer-readable storage medium according to claim 7, wherein the program controls the computer to detect which one of upward, downward, rightward, and leftward directions is the movement direction of the object, based on the object data recorded in the plurality of continuous shot data items when the program controls the computer to detect the movement direction.

10. The non-transitory computer-readable storage medium according to claim 7, wherein the program controls the computer to determine the arrangement of the plurality of continuous shot data items such that the plurality of continuous shot data items are arranged in lines of a predetermined number greater than or equal to one.

11. The non-transitory computer-readable storage medium according to claim 10, wherein the program controls the computer to determine the arrangement of the plurality of continuous shot data items such that images of a predetermined number are arranged in each of the lines of the number greater than or equal to one.

12. The non-transitory computer-readable storage medium according to claim 7, wherein the detected movement direction is a direction from right to left.

13. An image arrangement determination device comprising:
a control unit configured to read a plurality of image data items stored in a storage unit,
wherein the control unit is configured to:
distinguish a series of a plurality of continuous shot data items created by continuous shooting from the plurality of image data items,
detect a movement direction of an object expressed by object data recorded in the distinguished series of the plurality of continuous shot data items from the series of the plurality of continuous shot data items, and
determine a direction in which the plurality of continuous shot data items are to be arranged, based on the detected movement direction, and determine the arrangement of the series of the plurality of continuous shot data items such that the plurality of continuous shot data items are arranged in chronological order in the arrangement direction.

14. The image arrangement determination device according to claim 13, wherein the detected movement direction is a direction from right to left.

15. A printing device comprising:
a control unit configured to read a plurality of image data items stored in a storage unit; and
a printing unit configured to print the image data items read by the control unit on a medium,
wherein the control unit is configured to:
distinguish a series of a plurality of continuous shot data items created by continuous shooting from the plurality of image data items,
detect a movement direction of an object expressed by object data recorded in the distinguished series of the plurality of continuous shot data items from the series of the plurality of continuous shot data items,
determine a direction in which the plurality of continuous shot data items are to be arranged, based on the detected movement direction, and determine the arrangement of the series of the plurality of continuous shot data items such that the plurality of continuous shot data items are arranged in chronological order in the arrangement direction, and
cause the printing unit to print the series of the plurality of continuous shot data items on the medium in accordance with the determined arrangement.

16. The image arrangement determination device according to claim 15, wherein the detected movement direction is a direction from right to left.

17. A display device comprising:
a control unit configured to read an image data item from a storage unit in which a plurality of image data items are stored; and
a display unit configured to display the image data item read by the control unit,
wherein the control unit is configured to:
distinguish a series of a plurality of continuous shot data items created by continuous shooting from the plurality of image data items stored in the storage unit,
detect a movement direction of an object expressed by object data recorded in the distinguished series of the plurality of continuous shot data items from the series of the plurality of continuous shot data items,
determine a direction in which the plurality of continuous shot data items are to be arranged, based on the detected movement direction, and determine the arrangement of the series of the plurality of continuous shot data items such that the plurality of continuous shot data items are arranged in chronological order in the arrangement direction, and
cause the display unit to display the series of the plurality of continuous shot data items in accordance with the determined arrangement.

18. The display device according to claim 17, wherein the detected movement direction is a direction from right to left.
